(19) United States
(12) Patent Application Publication
(10) Pub. No.: US 2024/0400827 A1
(43) Pub. Date: Dec. 5, 2024

(54) SILOXANE COMPOSITION FOR LOWER TEMPERATURE ADHESION

(71) Applicant: Gelest, Inc., Morrisville, PA (US)

(72) Inventors: Michael John WATSON, Warrington, PA (US); Arthur Michael Flanagan, Philadelphia, PA (US); Scott Robert Ellis, Robbinsville, NJ (US)

(21) Appl. No.: 18/407,712

(22) Filed: Jan. 9, 2024

Related U.S. Application Data
(60) Provisional application No. 63/469,849, filed on May 31, 2023.

(51) Int. Cl. C08L 83/04; C09D 183/04; C09J 183/04

(52) U.S. Cl. CPC C08L 83/04; C09D 183/04; C09J 183/04; C08G 77/70; C08L 2205/025

(57) ABSTRACT

Organosiloxane compositions that cure by a catalyzed hydrosilylation reaction are provided. These curable organosiloxane compositions exhibit excellent adhesion at lower temperature cure to a variety of substrates which the compositions are in contact with during curing.

### CROSS-REFERENCE TO RELATED APPLICATION

This application claims priority to U.S. provisional patent application No. 63/469,849, filed May 31, 2023, the disclosure of which is herein incorporated by reference in its entirety.

### BACKGROUND OF THE INVENTION

Polyorganosiloxane elastomers, adhesives, and gels, such as polydimethylsiloxane-based elastomers, are frequently used in the electronics industry for properties such as their thermal stability, environmental stability, and ability to relieve stresses over a broad thermal range. Curable organopolysiloxane compositions are widely used as protectant compositions of electronic devices and parts. Typically, performance in these applications requires adhesion to the surfaces of metals and plastics of an electronic assembly in order to protect the assembly from heat, the environment, and mechanical stress.

Electronics are now ubiquitous in modern day society. Over time it has been common for new electronic devices to be lower in cost than when these devices were first invented. This has driven the use of thermoplastic elastomers in electronic devices for connectors and other applications that were not used in the past. Many of these thermoplastic elastomers have lower softening points, below 100° C. Silicone elastomers, adhesives, and gels with self-bonding capability to electronic substrates typically require heating temperatures of 100° C. or above to obtain the adhesion to electronics substrates. Therefore, lower curing temperatures which obtain adhesion are required.

Many self-bonding platinum catalyzed hydrosilylation cured polyorganosiloxane compositions that cure and have adhesion using heat to cure the compositions have been reported in the past. Some examples include those described by Mine (U.S. Pat. No. 4,082,726), Schulz (U.S. Pat. No. 4,087,585), Pouchelon (U.S. Pat. No. 8,557,942), and Bohin (U.S. Pat. No. 6,562,180). Mine and Schulz use alkoxy, epoxy, and vinyl functional oligomers as adhesion additives. Pouchelon uses a combination of vinyltrimethoxysilane (VTMO) and 3-glycidoxypropyltrimethoxysilane (GLYMO) to obtain adhesion. Bohin utilizes a similar blend of silanes to obtain adhesion along with a metal containing transesterification catalyst. All of these formulations typically need to cure at temperatures above 100° C. to obtain adhesion.

Fujisawa (U.S. Pat. No. 11,555,118) and Jandke (U.S. Pat. No. 8,314,200) utilize a diorganosiloxane additive with only two SiH functional groups as part of the adhesion promoter package in their platinum catalyzed hydrosilylation cured silicone formulations. Fujisawa also utilizes a monosiliconhydride/alkoxy functional oligomer in addition to the other adhesion additive. Jandke uses alkoxy alpha silanes as the second adhesion promoter. Both types of compositions can cure and have adhesion at room temperature. However, the Jandke products have very low durometer and the Fujisawa materials cure in eight hours or longer at room temperature. Accordingly, low curing temperature materials without these shortcomings would be desirable.

### BRIEF SUMMARY OF THE INVENTION

Aspects of the disclosure relate to a curable organopolysiloxane composition comprising:
(I) an organopolysiloxane/silicon resin blend comprising an organopolysiloxane having an average of at least two alkenyl organic groups per molecule and an MQ silicone resin having at least one alkenyl group per molecule,
(II) an organohydrogenpolysiloxane having an average of greater than two silicon-bonded hydrogen atoms per molecule,
(III) a hydrosilylation catalyst,
(IV) at least one alkoxy functional adhesion promoter, and
(V) a trialkoxy-containing siloxane having formula (1):

HR¹₂SiOR¹₂Si(CH₂)ₐSi(OR²)₃ (1)
wherein R¹ is a linear or branched alkyl group containing 1 to about 10 carbon atoms, an aryl group containing about 6 to about 10 carbon atoms, or an arylalkyl group containing about 6 to about 12 carbon atoms, R² is a linear or branched alkyl group containing 1 to about 4 carbon atoms, and a is an integer between about 1 and 10, and
wherein a total amount of silicon-bonded hydrogen atoms from components (II) and (V) with respect to a total number of alkenyl groups in the composition is about 0.3 to 10.

Further aspects of the disclosure relate to a curable organopolysiloxane composition comprising:
(I) 100 parts of an organopolysiloxane/silicon resin blend comprising an organopolysiloxane having an average of at least two alkenyl organic groups per molecule and an MQ silicone resin having at least one alkenyl group per molecule, wherein the MQ resin is about 5 to about 40 mass percent of the composition;
(II) about 0.1 to about 30 parts of an organohydrogenpolysiloxane having an average of greater than two silicon-bonded hydrogen atoms per molecule,
(III) a hydrosilylation catalyst,
(IV) at least one alkoxy functional adhesion promoter, and
(V) about 0.05 to about 10 parts of a trialkoxy-containing siloxane having formula (2):

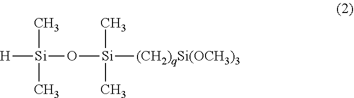

wherein q is about 2 to about 6; and
wherein a total amount of silicon-bonded hydrogen atoms from components (II) and (V) with respect to a total number of alkenyl groups in the composition is about 0.3 to 10.

### DETAILED DESCRIPTION OF THE INVENTION

Aspects of the disclosure relate to curable organosiloxane compositions which cure by a catalyzed hydrosilylation reaction. More particularly, aspects of the disclosure relate to curable organosiloxane compositions of this type that exhibit excellent adhesion at lower temperature cure to a variety of substrates which the compositions are in contact with during curing.

The compositions described herein contain an organopolysiloxane polymer with alkenyl groups, an MQ organosiloxane resin, a siliconhydride-containing organopolysiloxane, adhesion promoter(s), a catalyst, and a siliconhydride/alkoxysilane-containing organosiloxane. Typical formulations such as these without the siliconhydride/alkoxysilane containing organosiloxane normally require temperatures over 100° C. to obtain adhesion to common electronic substrates. The inclusion of a siliconhydride/alkoxysilane containing-organosiloxane allows for cure of the oganopolysiloxane compositions at temperatures below 100° C. with adhesion to substrate surfaces. For the purposes of this disclosure, the terms “composition” and “formulation” are synonymous and interchangeable.

Unless otherwise stated, any numerical value is to be understood as being modified in all instances by the term “about.” Thus, a numerical value typically includes ±10% of the recited value. For example, the recitation of a temperature such as “10° C.” or “about 10° C.” includes 9° C. and 11° C. and all temperatures therebetween.

All numerical ranges expressed in this disclosure expressly encompass all possible subranges, all individual numerical values within that range, including integers within such ranges and fractions and decimal amounts of the values unless the context clearly indicates otherwise. For example, an alkyl group having 1 to about 4 carbon atoms may be understood to include methyl, ethyl, propyl, isopropyl, n-butyl, sec-butyl, and t-butyl even if all possible functional groups are not specifically listed.

More specifically, organosiloxane compositions according to aspects of the disclosure are prepared by mixing the following components:
(I) an organopolysiloxane/silicon resin blend comprising an organopolysiloxane having an average of at least two alkenyl organic groups per molecule and an MQ silicone resin having at least one alkenyl group per molecule,
(II) an organohydrogenpolysiloxane having an average of greater than two silicon-bonded hydrogen atoms per molecule,
(III) a hydrosilylation catalyst,
(IV) at least one alkoxy functional adhesion promoter,
(V) a trialkoxy-containing siloxane having formula (1):

HR¹₂SiOR¹₂Si(CH₂)ₐSi(OR²)₃ (1)
(VI) optionally a cure rate inhibitor, and
(VII) optionally fillers and additives for performance and functionality.

In the composition, the total amount of silicon-bonded hydrogen atoms from components (II) and (V) with respect to the total number of alkenyl groups in all components is about 0.3 to 10, more preferably about 0.5 to about 3, even more preferably about 0.65 to about 2.2.

In formula (1), R¹ is a linear or branched alkyl group containing 1 to about 10 carbon atoms, an aryl group containing about 6 to about 10 carbon atoms, or an arylalkyl group containing about 6 to about 12 carbon atoms, R² is a linear or branched alkyl group containing 1 to about 4 carbon atoms, and a is an integer between about 1 and 10. As described below, in preferred embodiments, component (V) is preferably a compound having formula (2):

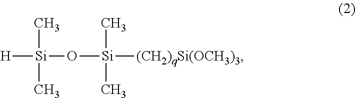

wherein q is an integer between 2 and about 10.

Each of these components will be described in detail below. The curable organopolysiloxane compositions described herein containing compounds (I), (II), (III), (IV), (V), and optionally (VI) and (VII) are lower cure temperature self-bonding (self-adhesive) platinum catalyzed hydrosilylation neutral curing elastomeric composition with the ability to have durometers over 10 Shore A, can cure quickly at elevated temperatures, and have adhesion to metals and plastics that are used in electronic assemblies when cured appropriately.

### Component (I)

Component (I) is an organopolysiloxane/silicone resin blend containing an organopolysiloxane polymer or copolymer having at least two alkenyl groups per molecule and an organopolysiloxane with at least one alkenyl group per molecule that exists as an MQ (preferably M^{Vi}Q or MM^{Vi}Q) silicone resin. These terms are well understood in the art and need not be described. The composition preferably contains about 5% to 40% by weight of the MQ silicone resin, more preferably about 10% to 30% by weight of the silicone resin, and even more preferably about 12% to 22% by weight of the silicone resin. Further, the blend preferably has a viscosity of about 100 to about 100,000 mPa-s, more preferably about 3,000 to 60,000 mPa-s, and most preferably, a viscosity of about 4,000 to 10,000 mPa-s. If the blend viscosity is greater than 100,000 mPa-s, wetting of bonding substrates can suffer and lack of adhesion can occur. If the blend viscosity is below 100 mPa-s, physical properties such as elongation, tear, and toughness may suffer.

The alkenyl groups in the organopolysiloxane polymer component of the component (I) blend may be linear or branched and may contain about two to about ten carbon atoms. Exemplary alkenyl groups include, without limitation, vinyl, allyl, butenyl, pentenyl, and hexenyl, with vinyl and hexenyl presently preferred. While not particularly limited thereto, exemplary bonding positions of this alkenyl group may particularly include a molecular chain terminal or a molecular chain side chain. The silicon atoms in the organosiloxane polymer may also contain organic groups other than the alkenyl group bonded thereto, such as, without limitation, monovalent hydrocarbon groups not having an aliphatic unsaturated bond and containing from about one to about ten carbon atoms, such as an alkyl group, cycloalkyl group, aryl group, aralkyl group, or halogenated alkyl group, etc., with an alkyl group and aryl group preferable, and with a methyl group and phenyl group particularly preferable. While the molecular structure of the organopolysiloxane polymer is not particularly limited, examples include a linear structure, partially branched linear structure, branched structure, cyclic structure, and dendritic structure; mixtures of two or more of these structures are also within the scope of the disclosure. That is, the organopolysiloxane may be a copolymer containing repeating units having two different molecular structures. Preferably, the organopolysiloxane polymer is linear.

Exemplary organopolysiloxane polymers which may be included in component (I) include, without limitation, a dimethylsiloxane/methylvinylsiloxane copolymer blocked by a trimethylsiloxy group at both terminals of a molecular chain, a dimethylsiloxane/methylvinylsiloxane/methylphenylsiloxane copolymer blocked by a trimethylsiloxy group at both terminals of a molecular chain, a dimethylpolysiloxane blocked by a dimethylvinylsiloxy group at both terminals of a molecular chain, a methylphenylpolysiloxane blocked by a dimethylvinylsiloxy group at both terminals of a molecular chain, a dimethylsiloxane/methylvinylsiloxane copolymer blocked by a dimethylvinylsiloxy group at both terminals of a molecular chain, a dimethylsiloxane/methylvinylsiloxane copolymer blocked by a dimethylphenylsiloxy group at both terminals of a molecular chain, and a dimethylpolysiloxane blocked by a methylvinylphenylsiloxy group at both terminals of a molecular chain.

The MQ silicon resin in the component (I) blend is preferably a M^{Vi}Q or MM^{Vi}Q silicone resin—having an MQ silicone resin structure with a dimethylvinyl on the M constituent and optionally some trimethyl, dimethylphenyl, phenylvinylmethyl, dipheneylvinyl, and/or diphenylmethyl functionality on the M constituent of the resin.

Component (I) is present in the composition in an amount of 100 parts by weight relative to the other components. As explained above, the composition contains about 5% to about 40% by weight of the MQ silicone resin.

### Component (II)

Component (II) is an organohydrogenpolysiloxane having three or more silicon-bonded hydrogen atoms per molecule.

Component (II) may be a linear, partially branched linear, branched, cyclic, or dendritic structured organohydrogenpolysiloxane molecule. While not limited thereto, the structure of component (II) is typically a cyclic, linear, or resin type:

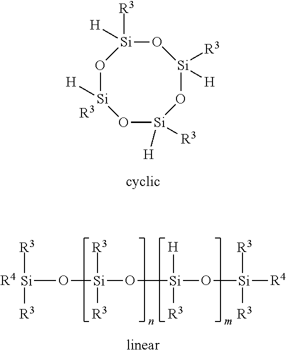

MM^{HQ} or M^{H}Q or M^{H}MQ resin

In these general structures, R³ is selected from hydrogen, alkyl groups having 1 to about 10 carbon atoms, and aryl groups having about 6 to about 10 carbon atoms, preferably hydrogen, methyl, or phenyl, and R⁴ is selected from hydrogen and alkyl groups having 1 to about 10 carbon atoms, preferably hydrogen or methyl. The sum of n and m are such that on average the number of silicon-bonded hydrogen atoms per molecule is greater than two. The component (II) siloxane preferably has a viscosity of about 10 to 10,000 mPa-s, preferably about 10 to 150 mPa-s, and most preferably about 10 to 50 mPa-s.

Component (II) is present in the composition in an amount of about 0.1 to about 30 parts, preferably about 0.5 to about 8 parts, relative to about 100 parts of component (I).

### Component (III)

Component (III) is a hydrosilylation catalyst for promoting a hydrosilylation reaction of an alkenyl group to a silicon-bonded hydrogen group. Preferred catalysts are platinum catalysts, such as the most preferred Karstedt's catalyst.

Appropriate platinum catalysts are well known in the art, such as, for example, and without limitation, platinum complexes of organic products described in U.S. Pat. Nos. 3,159,601; 3,159,602; and 3,220,972, European Patents Nos. EP 0057459, EP 0188978, and EP 0190530. Other platinum complexes of appropriate vinylorganosiloxanes include those described in U.S. Pat. Nos. 3,419,593; 3,715,334, and 3,814,730. It is also within the scope of the disclosure to utilize rhodium, palladium, iron, ruthenium, and iron/cobalt catalysts.

Typically, the components in the compositions described herein are provided as a two-part composition (such as in a kit, two-part container, or other configuration), in which the hydrosilylation catalyst and the silicon-bonded hydrogen siloxanes are in different sections. When mixed, the catalyst catalyzes the hydrosilylation reaction between the alkenyl group and the silicon-bonded hydrogen atom. However, these types of formulations can alternatively be made as one-part formulations.

While not limiting, an example of how to make a one-part silicone formulation using an encapsulated platinum catalyst is described in U.S. Pat. No. 5,887,237 of Saruyama. As described in Saruyama, the platinum catalyst is encapsulated in a thermoplastic to shield the catalyst from the silicon-bonded hydrogen atoms until the formulation is heated to release the catalyst. Alternatively, a ceramic-like structure could be used for the encapsulation. The thermal expansion of the catalyst within the core of the encapsulation shell would break the shell as the product is heated. This would then allow the hydrosilylation process to occur within the formulation. Another way to make a one-part formulation with adhesion would be to use a phosphine inhibitor, such as described in U.S. Pat. No. 7,494,694 of George.

As previously explained, the inclusion of a titanate or other very effective transesterification catalyst may lead to shelf life issues from premature reaction of the alkoxy silane components depending on how the product is formulated into parts, how it is packaged, how it is stored, the package type, and especially if the product is made into a one-part product.

Unlike some previously described compositions, a good transesterification catalyst such as tetrabutyltitanate or other titanates are preferably not included in the compositions described herein because they can cause the alkoxy silanes within the formulation to react prematurely with water that is in the formulation when packaged or water that seeps into the package upon storage. Inclusion of this type of catalyst which is good at transesterification requires more processing when packaging the formulation and better packaging to prevent excessive water in the formulation when packaging and water ingress into the formulation, respectively.

Component (III) is present in the composition in a catalytic amount, such as about 2 to about 100 ppm of Pt by mass, preferably about 5 to about 60 ppm by mass of Pt, more preferably about 4 to about 20 ppm by mass of Pt, relative to the total weight of the composition.

### Component (IV)

Component (IV) is an alkoxy functional adhesion promoter, and more specifically an alkoxy functional silane preferably having at least two alkoxysilyl groups per molecule. Appropriate alkoxy functional silanes include epoxy functional alkoxysilanes and alkenyl functional alkoxysilanes. It is also within the scope of the disclosure to include more than one alkoxy functional silane or more than one type of alkoxy functional silane in the composition.

Exemplary alkoxy functional adhesion promoters include, without limitation, bis(trimethoxysilyl)ethane; 1,2-bis(trimethoxysilyl)ethane; 1,2-bis(triethoxysilyl)ethane; 1,2 bis(methyldimethoxysilyl)ethane; 1,2-bis(methyldiethoxysilyl)ethane; 1,1-bis(trimethoxysilyl)ethane; 1,4-bis(trimethoxysilyl)butane; 1,4-bis(triethoxysilyl)butane; 1-methyldimethoxysilyl-4-trimethoxysilylbutane; 1-methyldiethoxysilyl-4-triethoxysilylbutane; 1,4-bis(methyldimethoxysilyl)butane; 1,4-bis(methyldiethoxysilyl)butane; 1,5-bis(trimethoxysilyl)pentane; 1,5-bis(triethoxysilyl)pentane; 1,4-bis(trimethoxysilyl)pentane; 1,4-bis(triethoxysilyl)pentane; 1-methyldimethoxysilyl-5-trimethoxysilylpentane; 1-methyldiethoxysilyl-5-triethoxysilylpentane; 1,5-bis(methyldimethoxysilyl)pentane; 1,5-bis(methyldiethoxysilyl)pentane; 1,6-bis(trimethoxysilyl)hexane; 1,6-bis(triethoxysilyl)hexane; 1,4-bis(trimethoxysilyl)hexane; 1,5-bis(trimethoxysilyl)hexane; 2,5-bis(trimethoxysilyl)hexane; 1-methyldimethoxysilyl-6-trimethoxysilylhexane; 1-phenyldiethoxysilyl-6-triethoxysilylhexane; 1,6-bis(methyldimethoxysilyl)hexane; 1,7-bis(trimethoxysilyl)heptane; 2,5-bis(trimethoxysilyl)heptane; 2,6-bis(trimethoxysilyl)heptane; 1,8-bis(trimethoxysilyl)octane; 2,5-bis(trimethoxysilyl)octane; 2,7-bis(trimethoxysilyl)octane; 1,9-bis(trimethoxysilyl)nonane; 2,7-bis(trimethoxysilyl)nonane; 1,10-bis(trimethoxysilyl)decane; 3,8-bis(trimethoxysilyl)decane; 3-glycidoxypropyltrimethoxysilane; 3-glycidoxypropylmethyldimethoxysilane; 2-(3,4-epoxy cyclohexyl)ethyltrimethoxysilane; 2-(3,4-epoxy cyclohexyl)ethylmethyldimethoxysilane; methyltrimethoxysilane; methyltriethoxysilane; ethyltrimethoxysilane; ethyltriethoxysilane; vinyltrimethoxysilane; phenyltrimethoxysilane; tetramethoxysilane; tetraethoxysilane; 3-methacryloxypropyltrimethoxysilane; 3-methacryloxypropyltriethoxysilane; 3-methacryloxypropylmethyldimethoxysilane; 3-acryloxypropyltrimethoxysilane; and 3-acryloxypropylmethyldimethoxysilane, as well as partially hydrolyzed condensates thereof.

Preferably, Component (IV) contains a combination of an epoxy functional alkoxysilane and optionally an alkenyl functional alkoxysilane. In preferred embodiments, the epoxy functional alkoxysilane is 3-glycidoxyprolyltrimethoxysilane or 3-glycidoxypropylmethyldimethoxysilane and the alkenyl functional alkoxysilane is vinyltrimethoxysilane, vinyltriethoxysilane, allyltrimethoxysilane, allyltriethoxysilane, hexenyltrimethoxysilane, or hexenyltriethoxysilane.

Adhesion promoter(s) (IV) is/are present in an amount to allow for adhesion of the cured organosiloxane composition when applied to a substrate and heated during cure. Component (IV) is present in the composition in an amount of about 0.3 parts to 0.67 parts by mass, more preferably about 1 to about 5 parts by mass, and most preferably about 1.5 to about 4 parts by mass, relative to about 100 parts of component (I).

### Component (V)

Component (V) is a trialkoxysilyl containing siloxane having formula (1) and functions as a secondary adhesion promoter:

HR¹₂SiOR¹₂Si(CH₂)ₐSi(OR²)₃ (1)

In formula (1), R¹ is a linear or branched alkyl group containing 1 to about 10 carbon atoms, an aryl group containing about 6 to about 10 carbon atoms, or an arylalkyl group containing about 6 to about 12 carbon atoms, R² is a linear or branched alkyl group containing 1 to about 4 carbon atoms, and a is an integer between about 1 and 10. Preferably, R¹ is methyl, ethyl, propyl, most preferably methyl and R² is preferably methyl, ethyl, propyl, or isopropyl. In preferred embodiments, R¹ and R² are methyl and a is about 2 to about 10, most preferably about 6. In preferred embodiments, component (V) is a compound having formula (2):

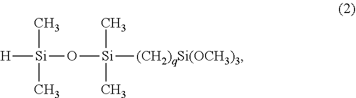

In formula (2), q is an integer between about 2 and about 10, more preferably about 2 to about 6, even more preferably about 4 to about 6, most preferably about 6.

Adhesion promoter component (IV) is present in an amount to allow for adhesion of the cured organosiloxane composition when applied to a substrate and heated during cure and secondary adhesion promoter (V) is present in an amount to allow for lower cure temperatures to be used to cure the compositions and still have adhesion to desired substrates relative to the temperature required when including only Component (IV). That is, including Component (V) lowers the temperature required to obtain cohesive bonding adhesion when compared with an analogous composition containing only adhesion promoter component (IV). Component (IV) is present in the composition in an amount of about 0.05 to about 10 parts, preferably about 0.5 to about 6 parts, more preferably about 1 to about 5 parts, relative to about 100 parts of component (I).

### Component (VI)

Optional component (VI) is a cure rate inhibitor, which may be a volatile inhibitor or a non-volatile inhibitor. Hydrosilylation cured silicone compositions need to cure at variable rates. Inclusion of a hydrosilylation catalyst typically allows for very fast cure, but many uses for such compositions need the cure to be adjusted to allow for use in particular production processes. Accordingly, cure rate inhibitors, sometimes called cure rate controllers, are frequently added to hydrosilylation cured formulations so that the cure rate can be adjusted as needed. These raw materials are well known in the art.

Exemplary volatile inhibitors include vinyl-containing cyclic organosiloxanes as described in U.S. Pat. No. 3,923,705 of Smith, acetylenic alcohols such as 2-methyl-3-butyn-3-ol and 1-ethynylcyclohexanol described in U.S. Pat. No. 3,445,420 of Kookoosedes, and some heterocyclic amines such as pyridine as disclosed in U.S. Pat. No. 3,188,299 of Chalk.

Exemplary non-volatile inhibitors include alkyl maleates as described in U.S. Pat. No. 4,256,870 of Ekberg and olefinic siloxanes described in U.S. Pat. No. 3,989,667 of Marko. Preferred inhibitors include 1,3,5,7-tetravinyl-1,3,5,7-tetramethylcyclotetrasiloxane, and 1-ethynylcyclohexanol.

Component (VI) is present in the composition in an amount of 0 to about 1 part, more preferably about 0 to about 0.6 parts, most preferably about 0 to about 0.2 parts.

### Component (VII)

Optionally, the composition contains one or more filler and one or more additives to improve performance and functionality. Appropriate fillers include reinforcing fillers, thermally conductive fillers, electrically conductive fillers, electrical performance modification fillers, flame retardants, light weight fillers, etc., or combinations thereof.

A reinforcing filler imparts mechanical strength to a cured silicone elastomer or gel and improves the performance as a protectant or adhesive. Examples of reinforcing fillers include inorganic fillers such as fumed silica, precipitated silica, fumed titanium dioxide, quartz (such as quartz powder), calcium carbonate, diatomaceous earth, aluminum oxide, aluminum hydroxide, zinc oxide, and zinc carbonate. These fillers may also be treated with surface treating agents to compatibilize the fillers for use in a silicone formulation. Such filler treatments may include organoalkoxysilanes such as a methyltrimethoxysilane, organohalosilanes such as a trimethylchlorosilane, organosilazanes such as hexamethyldisilazane, and siloxane oligomers such as a dimethylsiloxane oligomer blocked by an α,ω-silanol group, a methylphenylsiloxane oligomer blocked by an α,ω-silanol group, and a methylvinylsiloxane oligomer blocked by an α,ω-silanol group. In particular, by treating the surface of component (VII) in advance with an organopolysiloxane of a low degree of polymerization having a silanol group at both terminals of a molecular chain (suitably, a dimethylpolysiloxane blocked by an α,ω-silanol group not having reactive functional groups other than the terminal silanol group in the molecules).

Pigments may be included in the formulations or compositions described herein such as to allow for users of the compositions to distinguish between the parts of a two-part formulation or to allow users to use the product and hide what is coated or encapsulated within the composition.

Examples of thermally conductive additives include aluminum oxide, boron nitride, metal powders, aluminosilicates, and combinations of these. Electrically conductive fillers include graphite, graphene, silver fillers, electrically conductive carbon black, conductive metals, and combinations of these.

Component (VII) is present in the composition in an amount of 0 to about 65 parts, more preferably 0 to about 50 parts, most preferably 0 to about 45 parts.

In the compositions described herein, the total amount of silicon-bonded hydrogen atoms from components (II) and (V) with respect to the total number of alkenyl groups in all components is about 0.3 to 10., more preferably about 0.5 to about 3, even more preferably about 0.65 to about 2.2.

### Methods of Formulating Compositions

Methods for making the compositions described herein are not limited and may be performed by any method commonly employed in the art or to be discovered.

As previously explained, the compositions described herein are typically two-part formulations: a first part which contains at least components (I) and (III) and typically also component (VII), and a second part which contains at least components (I), (II), and (V), and typically also components (VI), and (VII). Component (IV) may be in either part of the two-part formulation, but is typically in the second part.

The first part of the two-part formulation is prepared by adding component (I) and part of component (VII) to a container, then mixed using a mixer that blends the components thoroughly. Preferably a tri-shaft mixer, a dynamic mixing blade, a centrifugal mixer, or a planetary mixer is employed, more preferably a tri-shaft mixer or a centrifugal mixer, but any mixer known in the art or to be developed may be employed. More of component (VII) is added and mixed until all of component (VII) has been added and blended thoroughly. The ratio of these components is dependent on the desired properties and the properties of the components. Once mixed, the blend is preferably left to cool to about 50° C. or below. Subsequently, component (III) is added and the product mixed while keeping the temperature at about 50° C. or below. The temperature is maintained at a low value for most hydrosilylation catalysts as ligands on the catalyst may volatilize. However, there are some catalysts that will not have this issue so this is only a typical recommendation and not limiting.

The second part of the two-part formulation may be prepared by adding some of component (I) to a container followed by component (VII). Mixing and further additions of each component may be performed as described for the first part of the two-part formulation. Once mixed and cooled, Component (VI) is preferably added next to the formulation. Mixing is preferably performed while maintaining the temperature at about 50° C. or below. When thoroughly mixed components, (II), (IV) and (V) may be added and mixed by maintaining the temperature at about 50° C. or below.

Preferably, an equal amount of filler (VII) is added to both the first and second parts of the two-part formulation. This ensures that when mixing the two-parts they can be added to containers in equal parts by weight or volume.

Once the two parts have been formulated, some of the first part may be added to a container followed by an equal (or appropriate) mass of the second part. The product may be mixed by hand, using a tri-shaft mixer, using a dynamic mixer blade, using a centrifugal mixer, or using a planetary mixer.

If possible, while mixing, the blend may be mixed at a vacuum level of about 0.5 to 10 mm Hg or the product may be deaired after mixing before pouring into an electronic enclosure or onto an electronic device.

After deairing the blend, the blend is poured into an electronic enclosure containing an electronic device or onto an electronic device or sensor, the potting compound blend is then heated to an appropriate temperature for an appropriate time to cure the product and obtain adhesion. The heating temperature and time may be as low as about 80° C. for about 30 minutes. The temperature and time required are dependent on the materials to which adhesion is needed and the mass of the part to be encapsulated or adhered to. In some embodiments, the composition is room temperature curable.

A one-part formulation may be formulated by mixing together components (I) and (VII) as previously described for the two-part formulation, followed by mixing in component while keeping the mixing temperature below about 50° C. or below until the blend is thoroughly mixed. Components (II), (IV), and (V) may be added to the blend and mixed at about 50° C. or below until the blend is thoroughly mixed. Finally, an encapsulated hydrosilylation catalyst or a highly inhibited hydrosilylation catalyst (III) may be added to the formulation and mixed at about 50° C. or below until the blend is thoroughly mixed.

These one-part formulations are often stored at temperatures below room temperature to avoid water ingress into the storage container. Cold storage extends the shelf life of the product. Use of an encapsulated hydrosilylation catalyst component prevents hydrosilylation of the composition components, so that the composition is stable until exposure to a trigger such as, for example, heat or ultraviolet light.

The one-part product may then be poured into an electronic enclosure or onto an electronic device, and the potting compound is then heated to an appropriate temperature for an appropriate time to cure the product and obtain adhesion. The heating temperature and time may be as low as about 80° C. for 30 minutes. The temperature and time required are dependent on the materials to which adhesion is needed, the inhibitor levels used, and the mass of the part to be encapsulated or adhered to.

The compositions described herein have higher durometer for use as potting materials, tough coatings, and adhesives for electronics and other applications. They may also be used as soft gels so these compositions can be used for a wider range than previously reported formulations. Since the inventive composition can cure very quickly at elevated temperatures, they are more easily adopted and usable for electronics and other customers that need higher speed production processes. They may still be cured quickly with heat and have adhesion at lower temperatures if needed and can be cured very quickly with higher temperatures for those applications that do not have the low temperature TPE materials used in assemblies.

In some embodiments, further aspects of the disclosure relate to protectants for electronic components, devices, or assemblies comprise a coating, potting material, encapsulant, or adhesive comprising the curable composition as described herein. In some embodiments, further aspects of the disclosure relate to a protected electric or electronic equipment part obtained by encapsulating, potting, or sealing an electric or electronic equipment part with a curable organopolysiloxane composition as described herein.

The invention will now be described in connection with the following, non-limited Examples.

### EXAMPLES

### Components For Preparing Compositions 1-16

The following components were employed to make a series of inventive and comparative compositions, as described below. Inventive compositions are numbered 2, 3, 4, 6, 7, 8, 9, 10, 11, 12, 13, and 14, and comparative compositions are numbered 1, 5, 15, and 16. Except for component (V), which is prepared by a proprietary method, all of the components described herein are commercially available, such as from Gelest, Sigma-Aldrich, or DeWolf Chemical.

Component (I) is a polyorganosiloxane having an average of at least two unsaturated organic groups per molecule blended with an M^{Vi}Q silicone resin. The viscosity is 5310 mPa-s, the vinyl content is 0.24 mmol/g, and the blend contains 16% by weight of the M^{Vi}Q silicone resin.

Component (II) is an α,ω-trimethylsiloxy terminated methylhydrosiloxane-dimethylsiloxane copolymer. The viscosity is 31.6 mPa-s and the mole percent methylhydrosiloxane in the polymer is 28.15%.

Component (III) is a platinum Karstedt's catalyst with 3.2% platinum metal content.

Component (IV) contains 3-glycidoxypropyltrimethoxysilane and allyltriethoxysilane.

Component (V) has the following structure

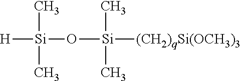

where q is 2-6.

Components (V-1), (V-2), and (V-3) have the following structures:

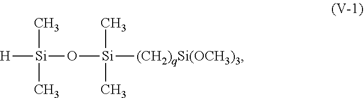

where q=2

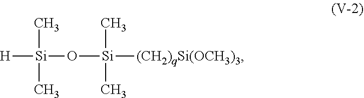

where q=3

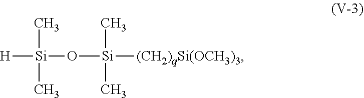

where q=6

Component (VI) is 1-ethynylcyclohexanol.

Component (VII) consists of two fillers and one pigment: a fumed silica with 200 m²/g surface area and trimethylsiloxy treatment, a ground quartz filler with an average particle size of 2 microns, and an FD&C Blue #1 Aluminum Lake High (28-31%) powdered blue pigment.

### Adhesion Substrates for Testing Compositions 1-16

For testing of the inventive and comparative compositions, adhesion substrates included aluminum, copper, epoxy-fiberglass, and steel. Specifically, the aluminum was 3003 H14 aluminum with a mill finish. The copper surface is on 1.5 mm FR4 epoxy-fiberglass one-sided printed circuit board panels. One side is used for testing adhesion to copper. The other side is used for testing the adhesion to epoxy-fiberglass. The steel substrates are flat polished cold rolled steel. Substrates were commercially obtained from Q-Lab, Uxcell, and McMaster-Carr.

### Example 1: Preparation of Pre-Blend Part A-1

A pre-blend of Part A was prepared to test with the Pre-Blend Part B's and with various added components to determine the temperature at which the hydrosilylation cured silicone composition will cure with cohesive failure type adhesion. 22.5 grams of fumed silica were added to a plastic 300 GRAM MAX SpeedMixer cup purchased from FlackTek Manufacturing, Inc. 48 grams of fumed silica were added to the same cup, followed by 228.84 grams of the vinyl siloxane/M^{Vi}Q silicone resin blend, and then 0.1 grams of pigment. This blend was mixed thoroughly on a FlackTek Manufacturing Inc. DAC 600 VAC SpeedMixer (centrifugal mixer). Once this portion was thoroughly mixed and the temperature was below 50° C., 0.36 grams of platinum Karstedt's catalyst was added and immediately mixed in thoroughly by hand with a spatula. Then the blend was mixed again on the FlackTek Manufacturing Inc. DAC 600 VAC SpeedMixer. Other mixers would also be appropriate for use in all of the examples described herein.

### Example 2: Preparation of Pre-Blend Part B-1

A pre-blend of Part B was prepared to test with the Pre-Blend Part A-1 and with various added components to determine the temperature at which the hydrosilylation cured silicone composition will cure with cohesive failure type adhesion. 22.5 grams of fumed silica were added to a plastic 300 GRAM MAX SpeedMixer cup purchased from FlackTek Manufacturing, Inc. 48 grams of fumed silica were added to the same cup, followed by 184.38 grams of the vinyl siloxane/M^{Vi}Q silicone resin blend. This blend was mixed thoroughly on a FlackTek Manufacturing Inc. DAC 600 VAC SpeedMixer (centrifugal mixer). Once this portion was thoroughly mixed and the temperature was below 50° C., 38.1 grams of hydridemethyl/dimethyl silicone copolymer, 3.45 grams of 3-glycidoxypropyltrimethoxysilane, 3.45 grams of vinyltriethoxysilane, and 0.12 grams of 1-ethynylcyclohexanol were added to the cup and immediately mixed thoroughly by hand with a spatula. Then the blend was mixed again on the FlackTek Manufacturing Inc. DAC 600 VAC SpeedMixer.

### Example 3: Preparation of Pre-Blend Part B-2

A pre-blend of Part B was prepared to test with the Pre-Blend Part A-1 and with various added components to determine the temperature at which the hydrosilylation cured silicone composition will cure with cohesive failure type adhesion. 7.5 grams of fumed silica were added to a plastic 100 GRAM MAX SpeedMixer cup purchased from FlackTek Manufacturing, Inc. 16 grams of fumed silica were added to the same cup, followed by 61.14 grams of the vinyl siloxane/M^{Vi}Q silicone resin blend. This blend was mixed thoroughly on a FlackTek Manufacturing Inc. DAC 600 VAC SpeedMixer (centrifugal mixer). Once this portion was thoroughly mixed and the temperature was below 50° C., 12.67 grams of hydridemethyl/dimethyl silicone copolymer, 1.5 grams of 3-glycidoxypropyltrimethoxysilane, 1.15 grams of vinyltriethoxysilane, and 0.04 grams of 1-ethynylcyclohexanol were added to the cup and immediately mixed thoroughly by hand with a spatula. Then the blend was mixed again on the FlackTek Manufacturing Inc. DAC 600 VAC SpeedMixer.

### Example 4: Preparation of Pre-Blend Part B-3

A pre-blend of Part B was prepared to test with the Pre-Blend Part A-1 and with various added components to determine the temperature at which the hydrosilylation cured silicone composition will cure with cohesive failure type adhesion. 7.5 grams of fumed silica were added to a plastic 100 GRAM MAX SpeedMixer cup purchased from FlackTek Manufacturing, Inc. 16 grams of fumed silica were added to the same cup, followed by 60.58 grams of the vinyl siloxane/M^{Vi}Q silicone resin blend. This blend was mixed thoroughly on a FlackTek Manufacturing Inc. DAC 600 VAC SpeedMixer (centrifugal mixer). Once this portion was thoroughly mixed and the temperature was below 50° C., 13.23 grams of hydridemethyl/dimethyl silicone copolymer, 1.15 grams of 3-glycidoxypropyltrimethoxysilane, 1.5 grams of vinyltriethoxysilane, and 0.04 grams of 1-ethynylcyclohexanol were added to the cup and immediately mixed thoroughly by hand with a spatula. Then the blend was mixed again on the FlackTek Manufacturing Inc. DAC 600 VAC SpeedMixer.

### Test Substrates and Test Method

All adhesives were tested using a high throughput gradient cure method with test composites placed between gradient heated aluminum plates. One end of each plate is heated, and the other end of each plate is cooled. Both plates are heated and cooled as close to identically as possible. Temperatures are measured along the plates and the relationship between distance and temperature when plates are heated as such is linear. Therefore, the temperature at any given point along the plates can be determined by distance. A method for curing composite samples between gradient heated plates is described in the journal Macromolecules 2007, 40, 11, 3904-3906 (Communication to the Editor, supporting materials).

For testing of the inventive and comparative compositions, adhesion substrates included aluminum, copper, epoxy-fiberglass, and steel.

Aluminum substrates were 3003 H14 aluminum with a mill finish. The aluminum substrates were obtained from Q-Lab as Stock No. A-46 and were 102 mm wide, 152 mm long, and 0.6 mm thick. These were cut in half for testing, making them approximately 51 mm wide and 152 mm long test substrates.

Regarding the copper and epoxy-fiberglass substrates, the copper surface is on 1.5 mm FR4 epoxy-fiberglass one-sided printed circuit board panels. One side is used for testing adhesion to copper. The other side is used for testing the adhesion to epoxy-fiberglass. One-sided copper clad FR4 epoxy-fiberglass printed circuit board (PCB) stock was used for the copper and epoxy-fiberglass substrate testing: Uxcell PCB stock 150 mm wide, 200 mm long, and 1.5 mm thick with copper deposited on just one side of the FR4 epoxy-fiberglass laminate. These were cut into 50 mm wide by 150 mm long test substrates.

Finally, the steel substrates are flat polished cold rolled steel obtained from Q-Lab: Q-Lab Stock No. S-36, 76 mm wide by 150 mm long and 0.8 mm thick. These substrates were used as received.

A thick aluminum foil, 1100 alloy at 0.15 mm thickness, was used to make peel test samples by sandwiching the silicone composition under test between this foil and the adhesion test substrate. A controlled bondline thickness was maintained by placing a 1.28 mm spacer at both ends of the sandwich. Testing was done by placing using a heating gradient from one end of the long length of the test substrates to the opposite end.

In the tests, an approximately 5 mm to 10 mm wide amount of the composition in liquid form was deposited air free along from one end to the other along the length of the adhesion test substrate. Spacers were set in place and then the aluminum foil was placed on top. This sandwich was placed on a gradient plate and then another gradient plate was placed on top (using the same temperature from one end of each gradient plate to the other. Pressure was applied to push the foil down to the level of the spacer. The spacers maintained a reproducible thickness of silicone composition between the test substrate and the foil. The two plates with the sandwiched substrate/silicone/foil were held for a known time and temperature versus a distance was measured so that temperatures on the test substrate would be known. Each test substrate temperature at one end was also measured so that when the distance was measured from that one end and the slope of temperature vs distance was calculated, the temperature at any point along the length of the test substrate could be known.

### Cleaning and Priming to Ensure Adhesion to the Flexible Foil and Repeatable Test Surfaces

Test substrates and the 0.8 mm foil were first cleaned thoroughly using isopropyl alcohol by aggressively wiping them down with the solvent using AA Wipes Nonwoven Cleanroom Wipes (55% cellulose/45% polyester). Then this process was repeated again with heptane using the same type of wipes.

The flexible foil that was adhered to the test substrate as above was primed with Dow Performance Silicones Sylgard Prime Coat by wiping with the clean room wipes and then quickly flooding the surface of the foil again followed by a gentle wipe to remove excess primer. These were left at temperatures between 21° C. and 25° C. and an R.H. of 40% to 56% for no less than 30 minutes and no longer than 4 hours before using them to make test sample laminates.

### Example 5: Preparation of Compositions 1-16

Compositions 1-16 were prepared with various amounts of Pre-Blend Part A, Pre-Blend Part B, and any (V-1), (V-2), or (V-3) components, as shown in Tables 1-5, all amounts in grams. The compositions were prepared by first adding the Pre-Blend Part B to a 40 GRAM MAX TALL plastic cup from FlackTek Manufacturing Inc. Then, the appropriate (V) components (V-1, V-2, or V-3) were added to the cup. The blend was mixed thoroughly on a FlackTek Manufacturing Inc. DAC 600 VAC SpeedMixer (centrifugal mixer). The appropriate Part A was then added to the cup and again the blend was mixed thoroughly on a FlackTek Manufacturing Inc. DAC 600 VAC SpeedMixer (centrifugal mixer). After mixing, the composition was applied as above to make a test laminate/sandwich. The primed foil was cut to 12.7 mm wide with an additional length hanging over the cold end of the test substrates (approximately 178 mm long).

### 90-Degree Peel Testing Method

The 12.7 mm wide foil was cut on the sides to ensure only the adhesion from one side of the 12.7 mm to the other was under test. The foil was pulled back by hand slowly for a short distance, then a cut was instituted between the cured silicone and the test substrate.

The test substrate was then mounted in a sled on an Instron 3345 Tensile Tester with a 1000 N load cell to measure testing force. The foil was pulled at a 90-degree angle to the test substrate at 50.8 mm/min. The force and distance were recorded as the sample was pulled.

The data from every test was downloaded and, using the slope of temperature vs distance from the heating plates and measuring the distance from the hot end to the starting cut point on the substrate, the test data were converted from force and distance to force and temperature. Measuring the distance from the hot end to the point at which cohesive adhesion failure began once the test is complete also provides the temperature at which cohesive failure begins given the heating time used for each test sample.

It should be noted that no failures of the cured silicone adhesives on the primed foil were observed. All samples with adhesion show bulk cohesive failure at the temperatures indicated in Tables 1-5 for the heating time in the Table.

Table 1 demonstrates an evaluation of the effectiveness of various hydride/alkoxy component (V) type additives to lower the temperature to obtain bulk cohesive failure on aluminum. Table 2 demonstrates an evaluation of the effectiveness of various hydride/alkoxy component (V) type additives to lower the temperature to obtain bulk cohesive failure on steel. Table 3 shows a comparison of performance of one component (V) type additive on different substrates. Table 4 demonstrates the effect of component (V) additive level on the adhesion temperature needed to obtain bulk cohesive failure after 2 hours of heating. Finally, Table 5 shows the superior performance of component (V) additive versus simply increasing adhesion promoter levels.

It may be seen by considering the data in Tables 1 to 5 that the best component (V) additive for the formulation to lower the temperature for adhesion in a given time was the component (V-3). All component (V) molecules reduced cure temperature needed compared to controls without the component (Composition 1).

TABLE 1
Evaluation of the effectiveness of various hydride/alkoxy
component (V) type additives to lower the temperature
to obtain bulk cohesive failure on aluminum

| | Part | Part |
|---|---|---|
| Pre-Blend Components | A-1 | B-1 |
| Vinyl siloxane/M^{Vi}Q resin blend | 228.84 | 184.38 |
| Quartz | 48 | 48 |
| Fumed silica | 22.5 | 22.5 |
| Pigment | 0.3 | |
| SIP6830.3, Pt catalyst | 0.36 | |
| SiHMeO/SiMe₂O copolymer crosslinker | | 38.1 |
| 3-glycidoxypropyltrimethoxysilane | | 3.45 |
| Vinyltriethoxysilane | | 3.45 |
| 1-Ethynylcyclohexanol | | 0.12 |

| | Composition Number | | | |
|---|---|---|---|---|
| Adhesion Test Components | 1 | 2 | 3 | 4 |
| Pre-Blend Part A-1 | 15 | 15 | 15 | 15 |
| Pre-Blend Part B-1 | 15 | 15 | 15 | 15 |
| Component (V-1) | | 0.3 | | |
| Component (V-2) | | | 0.3 | |
| Component (V-3) | | | | 0.3 |
| Adhesion Substrate* | Al | Al | Al | Al |
| Heating Time (hour) | 2 | 2 | 2 | 2 |
| Temperature Required for Cohesive | 166 | 131 | 112 | 105 |
| Failure Adhesion (° C.) | | | | |
| 90 Degree Peel Adhesion | | 1.39 | 1.23 | 1.27 |
| Strength (N/mm) | | | | |
| Durometer after cure at | 47 | 40 | 37 | 39 |
| 100° C./1 hour (Shore A) | | | | |

*Aluminum = Al, Copper = Cu, Epoxy-Fiberglass FR4 = Ep, Steel = St

TABLE 2
Evaluation of the effectiveness of various hydride/alkoxy
component (V) type additives to lower the temperature
to obtain bulk cohesive failure on steel.

| | Part | Part |
|---|---|---|
| Pre-Blend Components | A-1 | B-1 |
| Vinyl siloxane/M^{Vi}Q resin blend | 228.84 | 184.38 |
| Quartz | 48 | 48 |
| Fumed silica | 22.5 | 22.5 |
| Pigment | 0.3 | |
| SIP6830.3, Pt catalyst | 0.36 | |
| SiHMeO/SiMe₂O copolymer crosslinker | | 38.1 |
| 3-glycidoxypropyltrimethoxysilane | | 3.45 |
| Vinyltriethoxysilane | | 3.45 |
| 1-Ethynylcyclohexanol | | 0.12 |

| | Composition Number | | |
|---|---|---|---|
| Adhesion Test Components | 13 | 14 | 12 |
| Pre-Blend Part A-1 | 15 | 15 | 15 |
| Pre-Blend Part B-1 | 15 | 15 | 15 |
| Component (V-1) | 0.3 | | |
| Component (V-2) | | 0.3 | |
| Component (V-3) | | | 0.3 |
| Adhesion Substrate* | St | St | St |
| Heating Time (hour) | 2 | 2 | 2 |
| Temperature Required for Cohesive | 117 | 103 | 94 |
| Failure Adhesion (° C.) | | | |
| 90 Degree Peel Adhesion | 1.42 | 1.47 | 1.23 |
| Strength (N/mm) | | | |
| Durometer after cure at | 41 | 37 | 41 |
| 100° C./1 hour (Shore A) | | | |

*Aluminum = Al, Copper = Cu, Epoxy-Fiberglass FR4 = Ep, Steel = St

TABLE 3
Comparison of performance of one component
(V) type additive on difference substrates.

| | Part | Part |
|---|---|---|
| Pre-Blend Components | A-1 | B-1 |
| Vinyl siloxane/M^{Vi}Q resin blend | 228.84 | 184.38 |
| Quartz | 48 | 48 |
| Fumed silica | 22.5 | 22.5 |
| Pigment | 0.3 | |
| SIP6830.3, Pt catalyst | 0.36 | |
| SiHMeO/SiMe₂O copolymer crosslinker | | 38.1 |
| 3-glycidoxypropyltrimethoxysilane | | 3.45 |
| Vinyltriethoxysilane | | 3.45 |
| 1-Ethynylcyclohexanol | | 0.12 |

| | Composition Number | | | |
|---|---|---|---|---|
| Adhesion Test Components | 4 | 10 | 11 | 12 |
| Pre-Blend Part A-1 | 15 | 15 | 15 | 15 |
| Pre-Blend Part B-1 | 15 | 15 | 15 | 15 |
| Component (V-3) | 0.3 | 0.3 | 0.3 | 0.3 |
| Adhesion Substrate* | Al | Cu | Ep | St |
| Heating Time (hour) | 2 | 2 | 2 | 2 |
| Temperature Required for Cohesive | 105 | 87 | 83 | 94 |
| Failure Adhesion (° C.) | | | | |
| 90 Degree Peel Adhesion | 1.27 | 1.57 | 1.62 | 1.23 |
| Strength (N/mm) | | | | |
| Durometer after cure at | 39 | 41 | 42 | 41 |
| 100° C./1 hour (Shore A) | | | | |

*Aluminum = Al, Copper = Cu, Epoxy-Fiberglass FR4 = Ep, Steel = St

TABLE 4
Effect of component (V) additive level on the adhesion temperature
needed to obtain bulk cohesive failure after 2 hours of heating.

| Pre-Blend Components | Part A-1 | Part B-1 |
|---|---|---|
| Vinyl siloxane/M^{Vi}Q resin blend | 228.84 | 184.38 |
| Quartz | 48 | 48 |
| Fumed silica | 22.5 | 22.5 |
| Pigment | 0.3 | |
| SIP6830.3, Pt catalyst | 0.36 | |
| SiHMeO/SiMe₂O copolymer crosslinker | | 38.1 |
| 3-glycidoxypropyltrimethoxysilane | | 3.45 |
| Vinyltriethoxysilane | | 3.45 |
| 1-Ethynylcyclohexanol | | 0.12 |

| | Composition Number | | | | | |
|---|---|---|---|---|---|---|
| Adhesion Test Components | 1 | 6 | 7 | 3 | 8 | 9 |
| Pre-Blend Part A-1 | 15 | 15 | 15 | 15 | 15 | 15 |
| Pre-Blend Part B-1 | 15 | 15 | 15 | 15 | 15 | 15 |
| Component (V-2) | | 0.1 | 0.2 | 0.3 | 0.4 | 0.5 |
| Adhesion Substrate* | Al | Al | Al | Al | Al | Al |
| Heating Time (hour) | 2 | 2 | 2 | 2 | 2 | 2 |
| Temperature Required for Cohesive Failure Adhesion | 166 | 124 | 113 | 112 | 94 | 89 |
| (° C.) | | | | | | |
| 90 Degree Peel Adhesion Strength (N/mm) | | 1.17 | 1.57 | 1.23 | 1.33 | 1.33 |
| Durometer after cure at 100° C./1 hour (Shore A) | 47 | 44 | 42 | 37 | 34 | 32 |

*Aluminum = Al, Copper = Cu, Epoxy-Fiberglass FR4 = Ep, Steel = St

TABLE 5
Superior performance of component (V) additive versus
simply increasing adhesion promoter levels.

| | Normalized | | | |
|---|---|---|---|---|
| | Part | Part | Part | Part |
| Pre-Blend Components | A-1 | B-1 | B-2 | B-3 |
| Vinyl siloxane/M^{Vi}Q resin blend | 76.28 | 61.46 | 61.14 | 60.58 |
| Quartz | 16 | 16 | 16 | 16 |
| Fumed silica | 7.5 | 7.5 | 7.5 | 7.5 |
| Pigment | 0.1 | | | |
| SIP6830.3, Pt catalyst | 0.12 | | | |
| SiHMeO/SiMe₂O copolymer crosslinker | | 12.7 | 12.67 | 13.23 |
| 3-glycidoxypropyltrimethoxysilane | | 1.15 | 1.5 | 1.15 |
| Vinyltriethoxysilane | | 1.15 | 1.15 | 1.5 |
| 1-Ethynylcyclohexanol | | 0.04 | 0.04 | 0.04 |
| SiH/Vinyl Molar Ratio for | | 1.19 | 1.19 | 1.19 |
| Mixed Parts A&B | | | | |

| | Composition Number | | | |
|---|---|---|---|---|
| Adhesion Test Components | 1 | 15 | 16 | 3 |
| Pre-Blend Part A-1 | 15 | 15 | 15 | 15 |
| Pre-Blend Part B-1 | 15 | | | 15 |
| Pre-Blend Part B-2 | | 15 | | |
| Pre-Blend Part B-3 | | | 15 | |
| Component (V-2) | | | | 0.3 |
| Component (V-3) | | | | |
| Adhesion Substrate* | Al | Al | Al | Al |
| Heating Time (hour) | 2 | 2 | 2 | 2 |
| Temperature Required for Cohesive | 166 | >147° C. | 114 | 94 |
| Failure Adhesion (° C.) | | | | |
| 90 Degree Peel Adhesion | | | 1.82 | 1.23 |
| Strength (N/mm) | | | | |
| Durometer after cure at | 47 | 53 | 49 | 41 |
| 100° C./1 hour (Shore A) | | | | |

*Aluminum = Al, Copper = Cu, Epoxy-Fiberglass FR4 = Ep, Steel = St

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A curable organopolysiloxane composition comprising:
(I) an organopolysiloxane/silicon resin blend comprising an organopolysiloxane having an average of at least two alkenyl organic groups per molecule and an MQ silicone resin having at least one alkenyl group per molecule,
(II) an organohydrogenpolysiloxane having an average of greater than two silicon-bonded hydrogen atoms per molecule,
(III) a hydrosilylation catalyst,
(IV) at least one alkoxy functional adhesion promoter, and
(V) a trialkoxy-containing siloxane having formula (1):
HR¹₂SiOR¹₂Si(CH₂)ₐSi(OR²)₃ (1)
wherein R¹ is a linear or branched alkyl group containing 1 to about 10 carbon atoms, an aryl group containing about 6 to about 10 carbon atoms, or an arylalkyl group containing about 6 to about 12 carbon atoms, R² is a linear or branched alkyl group containing 1 to about 4 carbon atoms, and a is an integer between about 1 and 10, and
wherein a total amount of silicon-bonded hydrogen atoms from components (II) and (V) with respect to a total number of alkenyl groups in the composition is about 0.3 to 10.

2. The curable organopolysiloxane composition according to claim 1, wherein the MQ resin comprises about 5 to about 40 weight percent of the composition.

3. The curable organopolysiloxane composition according to claim 1, comprising about 100 parts by weight of component (I), about 0.1 to about 30 parts by weight of component (II), and about 0.05 to about 10 parts by weight of component (V).

4. The curable organopolysiloxane composition according to claim 1, wherein component (III) is present in a catalytic amount.

5. The curable organopolysiloxane composition according to claim 1, wherein component (V) has formula (2): 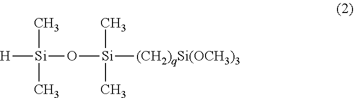
wherein q is about 2 to about 6.

6. The curable organopolysiloxane composition according to claim 1, wherein the adhesion promoter (IV) comprises at least one selected from:
(IV-1) 3-glycidoxypropyltrimethoxysilane;
(IV-2) vinyltriethoxysilane; and
(IV-3) an alkoxysilane containing molecule with more than two trialkoxysilane groups per molecule.

7. The curable organopolysiloxane composition according to claim 1, further comprising (VI) a cure rate inhibitor.

8. The curable organopolysiloxane composition according to claim 1, further comprising (VII) at least one inorganic filler.

9. The curable organopolysiloxane composition according to claim 8, wherein the at least one inorganic filler is selected from the group consisting of a fumed silica, quartz, aluminum oxide, and a combination thereof.

10. The curable organopolysiloxane composition according to claim 1, wherein the composition is room temperature or heat curable.

11. The curable organopolysiloxane composition according to claim 1, wherein the composition comprises one or two parts.

12. The curable organopolysiloxane composition according to claim 11, wherein the composition comprises two parts: a first part comprising at least components (I) and (III), and a second part comprising at least components (I), (II), and (V).

13. The curable organopolysiloxane composition according to claim 12, wherein at least one of the first part and the second part further comprises component (VI) and/or component (VII).

14. The curable organopolysiloxane composition according to claim 12, wherein at least one of the first part and the second part further comprises component (IV).

15. The curable organopolysiloxane composition according to claim 11, wherein the composition comprises one part.

16. The curable organopolysiloxane composition according to claim 15, wherein the hydrosilylation catalyst component (III) is encapsulated to prevent hydrosilylation of the composition components, and wherein the composition is stable until exposure to a trigger.

17. The curable organopolysiloxane composition according to claim 16, wherein the trigger is heat or ultraviolet light.

18. A curable organopolysiloxane composition comprising:
(I) 100 parts of an organopolysiloxane/silicon resin blend comprising an organopolysiloxane having an average of at least two alkenyl organic groups per molecule and an MQ silicone resin having at least one alkenyl group per molecule, wherein the MQ resin is about 5 to about 40 mass percent of the composition;
(II) about 0.1 to about 30 parts of an organohydrogenpolysiloxane having an average of greater than two silicon-bonded hydrogen atoms per molecule,
(III) a hydrosilylation catalyst,
(IV) at least one alkoxy functional adhesion promoter, and
(V) about 0.05 to about 10 parts of a trialkoxy-containing siloxane having formula (2): 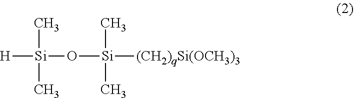
wherein q is about 2 to about 6; and
wherein a total amount of silicon-bonded hydrogen atoms from components (II) and (V) with respect to a total number of alkenyl groups in the composition is about 0.3 to 10.

19. A protectant for electronic components, devices or assemblies comprising a coating, potting material, encapsulant, or adhesive comprising the curable composition according to claim 1.

20. A protectant for electronic components, devices or assemblies comprising a coating, potting material, encapsulant, or adhesive comprising the curable composition according to claim 5.

21. A protectant for electronic components, devices or assemblies comprising a coating, potting material, encapsulant, or adhesive comprising the curable composition according to claim 18.

22. A protected electric or electronic equipment part obtained by encapsulating, potting, or sealing an electric or electronic equipment part with the curable organopolysiloxane composition according to claim 1.

23. A protected electric or electronic equipment part obtained by encapsulating, potting, or sealing an electric or electronic equipment part with the curable organopolysiloxane composition according to claim 5.

24. A protected electric or electronic equipment part obtained by encapsulating, potting, or sealing an electric or electronic equipment part with the curable organopolysiloxane composition according to claim 18.
